(19) United States
(12) Patent Application Publication
(10) Pub. No.: US 2007/0257888 A1
(43) Pub. Date: Nov. 8, 2007

(54) Adaptive text input modes for mobile electronic device

(76) Inventor: Weng Chong Chan, Tigard, OR (US)

Correspondence Address: SHARP LABORATORIES OF AMERICA, INC., 1320 PEARL ST., SUITE 228, BOULDER, CO, 80302, US

(21) Appl. No.: 11/416,612

(22) Filed: May 3, 2006

(51) Int. Cl. G09G 5/00

(52) U.S. Cl. 345/169

(57) ABSTRACT

Adaptive text input modes for a mobile electronic device permit efficient entry of hybrid alpha-numeric text records, such as street addresses and calendar dates, using a keypad. Adaptive text input modes automatically toggle between different text input modes in a manner that conforms to expected formats for text records. The number of keypad inputs is thereby reduced without the need for a user of the mobile electronic device to manually toggle between text input modes when entering text records on the keypad. The adaptive text input modes may be selected based on location information.

### BACKGROUND OF THE INVENTION

The present invention relates to text input modes for mobile electronic devices, and more particularly to adaptive text input modes for a mobile electronic device that permit efficient entry of text records having a hybrid of alphabetic and numeric characters, such as street addresses.

Due to size constraints, many mobile electronic devices, such as cellular and wireless Internet Protocol (IP) phones, support a 12-key telephonic keypad rather than a standard “qwerty” keyboard for text entry. A key on such a keypad typically represents multiple characters including a number between zero and nine and three or four letters. When a key on the keypad is depressed, the character generated on the display of the mobile electronic device depends upon an operative text input mode. For example, in a numeric text input mode, the number represented by the depressed key is generated on the display. In a multi-tap text input mode, the character represented by the depressed key that is generated on the display depends on how many times the key is tapped within a short time span (e.g. once=“a”; twice=“b”; thrice=“c”; four times=“2”). In a T9 text input mode, the mobile electronic device waits for a sequence of potentially different keys to be depressed and generates on the display a list of predicted words that a user may have intended from the sequence. The user can then select a word from the list.

None of these text input modes is adapted for efficient entry of text records that include a hybrid of alphabetic and numeric characters, such as street addresses. Depending on the level of specificity with which a street address is identified, a street address may comprise a building/house number, a street name, a suite/apartment number, a locality name a country name and a postal code number. Street, locality and country names cannot be entered using a numeric text input mode. While the entire street address can be entered using a multi-top text input mode, invoking this mode to enter an entire street address can require a frustratingly large number of keypad taps. Finally, numbers and fanciful names in street addresses render a T9 input mode's predictive approach ill-suited to street address entry. While a user can manually toggle back-and-forth between a numeric text input mode and a multi-top text input mode to reduce the number of tops (assuming both modes are supported on the mobile electronic device), such manual toggling itself requires additional taps and is time-consuming.

### SUMMARY OF THE INVENTION

The present invention permits efficient entry of hybrid alpha-numeric text records, such as street addresses, using a keypad on a mobile electronic device. Efficient entry of text records is achieved using adaptive text input modes. Adaptive text input modes automatically toggle between different text input modes in a manner that conforms to expected formats for text records. The number of keypad inputs is therefore reduced without the need for a user of the mobile electronic device to manually toggle between text input modes when entering such records on the keypad.

In one aspect, a method for generating a hybrid alpha-numeric text record on a mobile electronic device using a keypad comprises selecting an adaptive text input mode for the text record based on location information; and generating a plurality of characters of the text record in conformance with the adaptive text input mode in response to a respective plurality of inputs on the keypad. The adaptive text input mode may specify a first text input mode, a second text input mode and a mode delimiter for the text record. The first text input mode may be a numeric text input mode and the second text input mode may be a multi-tap text input mode. The plurality of inputs may include one or more single tap inputs and one or more multi-top inputs. The location information may be acquired from a network node, GPS satellite or a user of the mobile electronic device, or may be preconfigured on the device or on a smart card inserted into the device. The location information may include country information. The text record may include street address information or calendar date information.

In another aspect, a method for generating a hybrid alpha-numeric text record on a mobile electronic device using a keypad comprises selecting an adaptive text input mode specifying a first text input mode, a second text input mode and a mode delimiter applicable to the text record; in response to one or more first inputs on the keypad, generating one or more first characters of the text record in conformance with the first text input mode; in response to one or more second inputs on the keypad including the mode delimiter, switching between the first text input mode and the second text input mode; and, in response to one or more third inputs on the keypad, generating one or more second characters of the text record in conformance with the second text input mode. The adaptive text input mode may be selected based on location information. The location information may be obtained from a network node, a GPS satellite or a user of the mobile electronic device, or may be preconfigured on the device or on a smart card inserted into the device. The location information may include country information and the text record may include street address information or calendar date information.

In another aspect, a mobile electronic device comprises a memory adopted to store an adaptive text input mode; a keypad adapted to receive a plurality of inputs; and a processor communicatively coupled with the memory and the keypad and adapted to select the adaptive text input mode and generate a respective plurality of characters of a text record in conformance with the adaptive text input mode in response to the plurality of inputs. The adaptive text input mode may be selected based on location information. The adaptive text input mode may specify a first text input mode, a second text input mode and a mode delimiter for the text record.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 is a system diagram of a network in accordance with an embodiment of the present invention.

FIG. 2 is a block diagram of a mobile electronic device in accordance with an embodiment of the present invention.

FIG. 3 is a schematic of a keypad on a mobile electronic device in accordance with an embodiment of the present invention.

FIG. 4 is a block diagram of a main memory on a mobile electronic device in accordance with an embodiment of the present invention.

FIG. 5 is an adaptive input mode (AIM) table on a mobile electronic device in accordance with an embodiment of the present invention.

FIG. 6 is a flow diagram showing operation of a mobile electronic device in accordance with an embodiment of the present invention.

### DESCRIPTION OF THE PREFERRED EMBODIMENT

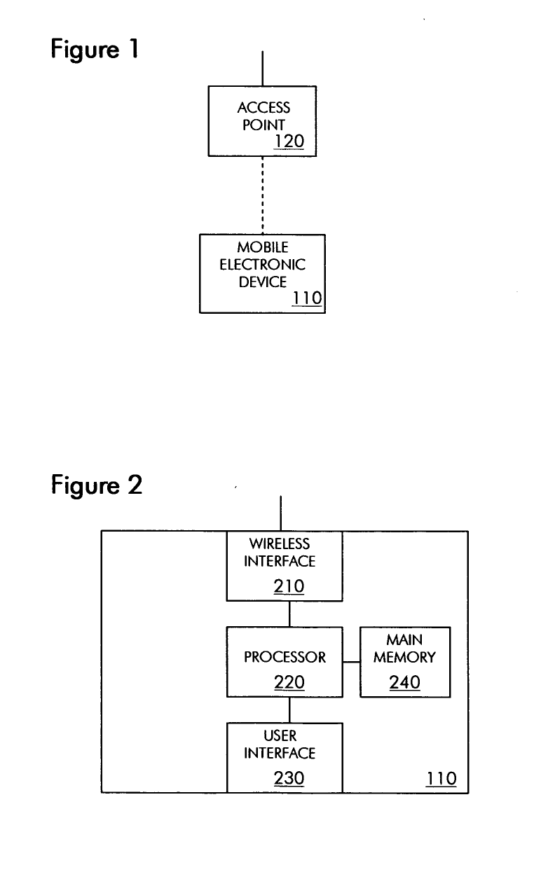

In FIG. 1, a network in accordance with one embodiment of the present invention is shown. The network includes a mobile electronic device 110 and an access point 120 communicatively coupled in a network infrastructure. Access point 120 may reside in an enterprise network or a service provider network, for example. Access point 120 may be, for example, a cellular base station or a wireless local area network (LAN) access point. Access point 120 has wireless connectivity with a mobile electronic device 110 via an over-air link. The over-air link may be one of various types of links over which data may be transmitted, such as a cellular link or LAN link. Mobile electronic device 110 may be, for example, a cellular or wireless IP phone. Another type of mobile electronic device having a keypad and wireless interface may be deployed in other embodiments.

Mobile electronic device 110 acquires location information respecting its approximate location. In some embodiments, mobile electronic device 110 acquires location information from access point 120. In those embodiments, access point 120 may learn its location through static configuration or a GPS receiver on access point 120 and transmit location information respecting its location to mobile electronic device 110 in a cellular or LAN transmission, for example. In some embodiments, location information is pulled from access point 120 pursuant to a request made by mobile electronic device 110. In other embodiments, location information is pushed by access point 120 to mobile electronic device 110 independent of any request. Alternatively, mobile electronic device 110 may acquire location information by consulting a database that maintains a stored association between a source identifier received from access point 120 and location information. In still other embodiments, mobile electronic device 110 may have an internal GPS receiver and acquire location information respecting its location from a GPS satellite.

In some embodiments, location information acquired by mobile electronic device 110 includes numeric coordinates or codes. In other embodiments, location information acquired by mobile electronic device 110 includes alphabetic or alpha-numeric names or addresses. Mobile electronic device 110 has device software adapted to resolve a present country identifier (present country ID) from acquired location information.

Turning to FIG. 2, mobile electronic device 110 in accordance with one embodiment of the present invention is shown in more detail. Device 110 includes a wireless interface 210 adapted to transmit and receive data in accordance with a wireless communication protocol, such as a cellular or wireless LAN protocol. Device 110 further includes a user interface 230 adapted to transmit outputs and receive inputs from a user of device 110. User interface 230 includes a display, such as a liquid crystal display (LCD), for transmitting outputs and a keypad for receiving inputs. Device 110 further includes a main memory 240 adapted to store device software, settings and tables. In some embodiments, memory 240 is a flash memory. Device 110 further includes a processor 220 communicatively coupled between elements 210, 230, 240. Processor 220 is adapted to execute device software stored in main memory 240, reference device settings and tables, and interoperate with elements 210, 230, 240 to perform various features and functions supported by device 110.

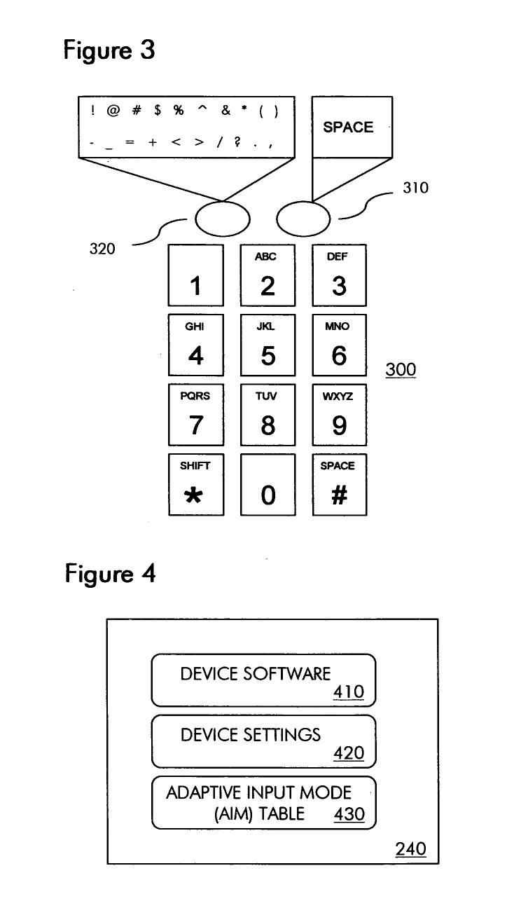

Turning to FIG. 3, a keypad 300 adapted to receive inputs from a user of device 110 in accordance with one embodiment of the present invention is shown. Inputs are received when a key on keypad 300 is depressed by a user of device 110. Processor 220 interprets inputs and in response generates characters on a display of user interface 230 and takes other indicated actions. Keypad 300 includes 12 hard keys and soft keys 310, 320. Two of the hard keys (“0” and “1”) represent a number and no letters. Depressing these hard keys results in generating “0” and “1”, respectively, on a display of user interface 230 regardless of the operative text input mode. Eight other hard keys represent a number between two and nine and three to four letters. For example, one of the hard keys represents the number “2” and the letters “a”, “b” and “c”. For these eight alpha-numeric hard keys, when device 110 is in numeric text input mode, depressing the key results in the number represented by the key being generated on the display, whereas when device 110 is in multi-tap text input mode, the character represented by the depressed key that is generated on the display depends on how many times the key is tapped (e.g. once=“a”; twice=“b”; thrice=“c”; four times=“2”; five times “a”; etc.) within a predetermined time span. The pound key represents the pound symbol and the space character. When in numeric text input mode, depressing the pound key results in generating “#” on the display whereas when in multi-top text input mode, the character represented by the key that is generated on the display depends on how many times the key is tapped (e.g. once=space character; twice=“#”) within a predetermined time span. A space character may be generated on the display in numeric text input mode by depressing right soft key 310. In other embodiments, a space character may be generated on the display in numeric text input mode by maintaining the pound key in a multi-tap state regardless of the operative text input mode. In still other embodiments, a keypad may have a hard key that is dedicated to the space character. The pound symbol, period, comma and other symbols may be generated on the display by depressing left soft key 320 and selecting the desired symbol. Symbol selection may be made using a touch-sensitive navigation tool (not shown) to scroll to the desired symbol followed by a second tap on left soft key 320, for example.

Turning to FIG. 4, main memory 240 is shown in more detail to include device software 410, device settings 420 and adaptive input mode (AIM) table 430. Device software 410 includes software programs having instructions adapted for execution by processor 220 to perform various features and functions supported by device 110. For example, device software 410 includes location resolution software adopted to resolve acquired location information into a present country ID and store the present country ID in device settings 420. Device software 410 also includes character resolution software adapted to resolve inputs received on keypad 300 into characters. Device settings 420 include a multiple of settings that affect how device 110 interfaces with the user. In one embodiment, device settings 420 include the present country ID and a preferred country identifier (preferred country ID). In those embodiments, the preferred country ID is user-selectable and prior to user selection the preferred country ID is a default country ID selected by a manufacturer of device 110. In other embodiments, a preferred country ID is preconfigured elsewhere in main memory 240 or on a smart card inserted into device 110. AIM table 430 includes entries that specify different adaptive text input modes for entry of text records, such as street addresses, corresponding to different country IDs.

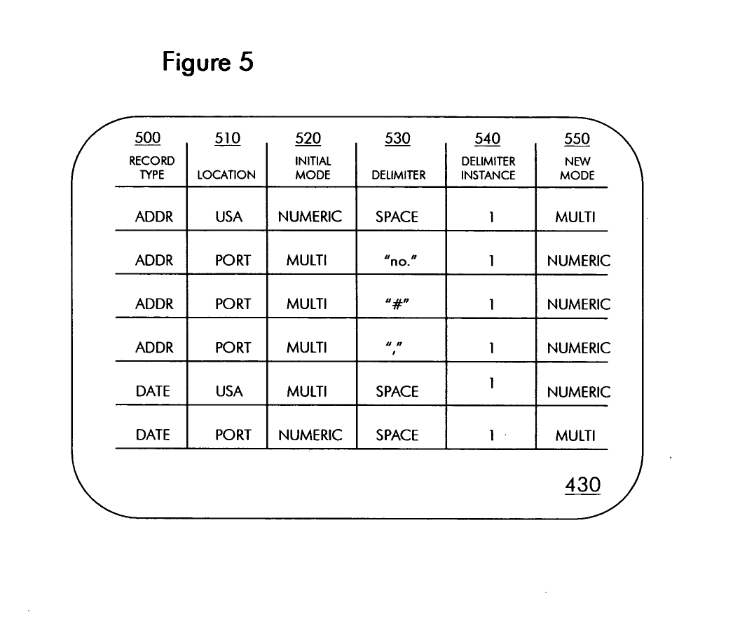

Turning to FIG. 5, AIM table 430 in accordance with one embodiment of the present invention is shown. AIM table 430 has multiple entries stored therein that are referenceable by processor 220. An AIM table entry specifies an adaptive text input mode or an element thereof for selective application when a user enters a text record, such as a street address, on device 110. Adaptive text input modes are selected based on location information. In the illustrated example, an AIM table entry has six informational elements including record type 500, location 510, initial mode 520, delimiter 530, delimiter instance 540 and new mode 550. Record type 500 specifies a type of text record to which the entry applies, such as a street address or calendar date, for example. Location 510 specifies the location, such as the country ID, to which the entry applies. Initial mode 520 specifies an initial text input mode, such as numeric (NUMERIC) or multi-tap (MULTI). Delimiter 530 specifies a character or character string which if encountered in a received input in an instance specified by delimiter instance 540 results in a text input mode switch from the current text input mode to a new text input mode specified by new mode 550.

In the example shown, AIM table 430 is populated with entries specifying adaptive text input modes for selective application based on an operative country ID when a user enters a street address or calendar date on device 200. For street address entry, AIM table 430 has a first entry specifying an adaptive text input mode for entering a building/house number and street name when the operative country ID is “USA” (i.e. the United States) and second through fourth entries specifying an adaptive text input mode for entering a street name and building/house number when the operative country ID is “PORT” (i.e. Portugal). For calendar date entry, AIM table 430 has a fifth entry specifying an adaptive text input mode for entering a month and day when the operative country ID is “USA” and a sixth entry specifying an adaptive text input mode for entering a day and month when the operative country ID is “PORT”.

A convention for street addressing in the United States is [building/house number] [SPACE] [street name]. Thus, when a street address is entered and the operative country ID is “USA”, the text input mode begins as numeric (NUMERIC) and continues as numeric until a first space character (SPACE, 1) is detected. When the first space character is detected, the text input mode switches to multi-tap (MULTI) and continues as multi-tap until input of the street address has been completed. This adaptive text input mode conforms to the house/building number first, street name second convention for street addressing in the United States.

A convention for street addressing in Portugal is [street name] [“no.”, “#” or “,”] [building/house number]. Thus, when a street address is entered and the operative country ID is “PORT”, the text input mode begins as multi-tap (MULTI) and continues as multi-tap until input of “no.”, “#” or “,” is detected. When “no.”, “#” or “,” is detected, the text input mode switches to numeric (NUMERIC) and continues as numeric until input of the street address has been completed. This adaptive text input mode conforms to the street name first, house/building number second convention for street addresses in Portugal.

A convention for calendar dating in the United States is [month] [SPACE] [day]. Thus, when a calendar date is entered and the operative country ID is “USA”, the text input mode begins as multi-tap (MULTI) and continues as multi-tap until a first space character (SPACE, 1) is detected. When the first space character is detected, the text input mode switches to numeric (NUMERIC) and continues as numeric until input of the calendar date has been completed. This adaptive text input mode conforms to the month first, day second convention for calendar dating in the United States.

A convention for calendar dating in Portugal is [day] [SPACE] [month]. Thus, when a calendar date is entered and the operative country ID is “PORT”, the text input mode begins as numeric (NUMERIC) and continues as numeric until a first space character (SPACE, 1) is detected. When the first space character is detected, the text input mode switches to multi-tap (MULTI) and continues as multi-tap until input of the calendar date has been completed. This adaptive text input mode conforms to the month first, day second convention for calendar dating in Portugal.

Naturally, AIM table 430 may be populated with additional entries specifying adaptive text input modes corresponding to street addressing and calendar dating conventions of other countries or more detailed or specific adaptive text input modes corresponding to more detailed or specific street addressing and calendar dating conventions of the United States or Portugal. As one example, a mobile electronic device may support additional variants of a delimiter for number such as “No.”, “number” and “Number”. As another example, a mobile electronic device may support entry of a suite/apartment number for street addresses in the United States, in which event AIM table 430 may have additional entries for “USA” such that when “#” or “apt.” or “ste.” or a variant thereof is detected the text input mode switches from multi-tap to numeric for entry of the suite/apartment number.

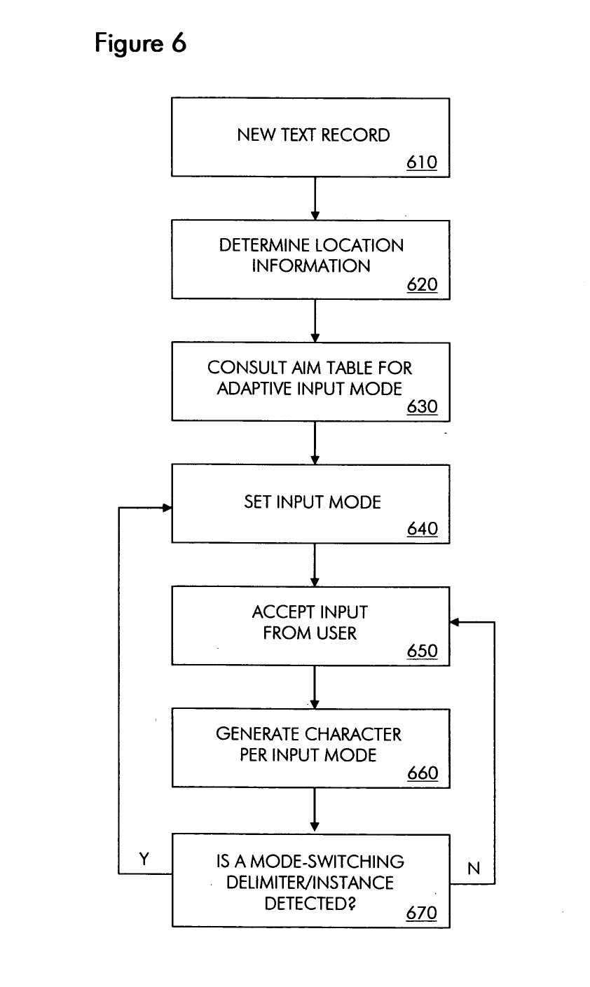

Turning to FIG. 6, a flow diagram showing operation of device 110 in accordance with an embodiment of the present invention is shown. A user indicates through inputs on keypad 300 that he or she wants to enter a new text record, such as a street address or calendar date (610). Processor 220 determines location information, such as a present country ID received from access point 120 or a preferred country ID selected by the user or preconfigured on a smart card (620). In one embodiment, processor 220 selects the present country ID as the operative country ID if valid and otherwise selects the preferred country ID as the operative country ID. Processor 220 consults AIM table 430 and reads the first entry corresponding to the operative record type and country ID for the initial text input mode (630). In one embodiment, the initial text input mode is one of a numeric text input mode and a multi-tap text input mode. Processor 220 invokes the initial text input mode as the operative text input mode (640) and receives an input from the user including one or more taps on keyboard 300 (650). Processor 220 resolves a character from the received input in accordance with the operative text input mode (660) and outputs the character on a display of user interface 230. Processor 220 again consults AIM table 430, reads entries corresponding to the operative record type and country ID and determines whether a text input mode switch is indicated (670). In particular, processor 220 determines whether the resolved character matches a delimiter in an entry corresponding to the operative country ID and, if so, whether the instance of the resolved character matches the delimiter instance in the entry (680). Alternatively, processor 220 can cache entries corresponding to the operative record type and country ID and consult the cache to make the determination in Step 670. If there is a delimiter and delimiter instance match, processor 220 reads the new text input mode from the entry and switches the operative text input mode to the new text input mode (640). If there is no such match, processor 220 receives the next input from the user (650) without changing the operative text input mode.

Returning now to FIG. 5, consider a user in the United States who wishes to add to device 110 a street address of “1234 park avenue” for one of his or her contacts. The user indicates through inputs on keypad 300 that he or she wants to enter a new street address. Processor 220 selects “ADDR” and “USA” as the operative record type and country ID, respectively. Processor 220 consults AIM table 430, reads the entry corresponding to “ADDR” and “USA” and invokes numeric as the initial text input mode. The user depresses the “1” key and processor 220 outputs “1” on a display of user interface 230. Processor 220 consults AIM table 430, reads entries corresponding to “ADDR” and “USA” and determines that a text input mode switch is not indicated. In particular, processor 220 determines that “1” is not a delimiter in an entry corresponding to “USA”. The user depresses the “2”, “3” and “4” keys and processor 220 similarly outputs “2”, “3” and “4” on the display without switching the text input mode. The user then depresses right soft key 310 that represents the space character in numeric mode and processor 220 outputs a space character on the display. Processor 220 consults AIM table 430, reads entries corresponding to “ADDR” and “USA” and determines that a text input mode switch is indicated. In particular, processor 220 determines that the space character matches a delimiter in an entry corresponding to “ADDR” and “USA” and that the instance of the space character in the street address (i.e. first) matches the delimiter instance in the entry. Processor 220 reads the new text input mode from the entry and switches the operative text input mode to multi-tap, whereafter additional inputs are received in multi-tap text input mode from which processor 220 resolves characters “p”, “a”, “r”, “k”, etc. and outputs them on the display.

Now consider that the some user wishes to add to device 110 a calendar date of “april 14” which is the birthday of one of his or her contacts. The user indicates through inputs on keypad 300 that he or she wants to enter a new calendar date. Processor 220 selects “DATE” and “USA” as the operative record type and country ID, respectively. Processor 220 consults AIM table 430, reads the entry corresponding to “DATE” and “USA” and invokes multi-tap as the initial text input mode. The user depresses the “2” key from which processor 220 resolves and outputs “a” on a display of user interface 230. Processor 220 consults AIM table 430, reads entries corresponding to “DATE” and “USA” and determines that a text input mode switch is not indicated. In particular, processor 220 determines that “a” is not a delimiter in an entry corresponding to “DATE” and “USA”. The user depresses additional keys from which processor 220 resolves and outputs “p”, “r”, “i” and ”l” on the display without switching the text input mode. The user then depresses right soft key 310 that represents the space character in multi-tap mode and processor 220 outputs a space character on the display. Processor 220 consults AIM table 430, reads entries corresponding to “DATE” and “USA” and determines that a text input mode switch is indicated. In particular, processor 220 determines that the space character matches a delimiter in an entry corresponding to “DATE” and “USA” and that the instance of the space character in the calendar date (i.e. first) matches the delimiter instance in the entry. Processor 220 reads the new text input mode from the entry and switches the operative text input mode to numeric, whereafter additional inputs are received from which processor 220 resolves characters “1” and “4” and outputs them on the display.

Now consider a user in Portugal who wishes to add to device 110 a street address of “rua de silva mendas, 25” for one of his or her contacts. The user indicates through inputs on keypad 300 that he or she wants to enter a new street address. Processor 220 selects “ADDR” and “PORT” as the operative record type and country ID, respectively. Processor 220 consults AIM table 430, reads the first entry corresponding to “ADDR” and “PORT” and invokes multi-tap as the initial text input mode. The user taps the “7” key three times in a short time span. Processor 220 resolves “r” from the received inputs in accordance with multi-tap text input mode and outputs “r” on the display. Processor 220 consults AIM table 430, reads entries corresponding to “ADDR” and “PORT” and determines that a text input mode switch is not indicated. In particular, processor 220 determines that “r” is not a delimiter in an entry corresponding to “ADDR” and “PORT”. Processor 220 similarly outputs “u”, “a”, space, “d”, “e”, etc. on the display without switching text input mode in response to further inputs. Eventually the user inputs “,” using an appropriate sequence of taps in multi-tap mode and processor 220 outputs “,” on the display. Processor 220 consults AIM table 430, reads all entries corresponding to “ADDR” and “PORT” and determines that a text input mode switch is indicated. In particular, processor 220 determines that “,” is a delimiter in an entry corresponding to “ADDR” and “PORT” and that the instance of “,” in the street address (i.e. first) matches the delimiter instance in the entry. Processor 220 reads the new text input mode from the entry and switches the operative text input mode to numeric, whereafter additional inputs are received in numeric text input mode from which processor 220 resolves “2” and “5” and outputs them on the display.

Finally, consider that the same user wishes to add to device 110 a calendar date of “27 abril” which is a date of a meeting with one of her contacts. The user indicates through inputs on keypad 300 that he or she wants to enter a new calendar date. Processor 220 selects “DATE” and “PORT” as the operative record type and country ID, respectively. Processor 220 consults AIM table 430, reads the entry corresponding to “DATE” and “PORT” and invokes numeric as the initial text input mode. The user depresses the “2” key and processor 220 outputs “2” on a display of user interface 230. Processor 220 consults AIM table 430, reads entries corresponding to “DATE” and “PORT” and determines that a text input mode switch is not indicated. In particular, processor 220 determines that “2” is not a delimiter in an entry corresponding to “DATE” and “PORT”. The user depresses the “7” key and processor 220 outputs “7” on the display without switching the text input mode. The user then depresses right soft key 310 that represents the space character in numeric mode and processor 220 outputs a space character on the display. Processor 220 consults AIM table 430, reads entries corresponding to “DATE” and “PORT” and determines that a text input mode switch is indicated. In particular, processor 220 determines that the space character matches a delimiter in an entry corresponding to “DATE” and “PORT” and that the instance of the space character in the calendar date (i.e. first) matches the delimiter instance in the entry. Processor 220 reads the new text input mode from the entry and switches the operative text input mode to multi-tap, whereafter additional inputs are received in multi-tap text input mode from which processor 220 resolves characters “a”, “b”, “r”, “i” and “l” and outputs them on the display.

It will be appreciated by those of ordinary skill in the art that the invention can be embodied in other specific forms without departing from the spirit or essential character hereof. For example, in some embodiments, the invention is applied to entry of text records other than street addresses or calendar dates. The present description is therefore considered in all respects to be illustrative and not restrictive. The scope of the invention is indicated by the appended claims, and all changes that come with in the meaning and range of equivalents thereof are intended to be embraced therein.

What is claimed is:

1. A method for generating a hybrid alpha-numeric text record on a mobile electronic device using a keypad, comprising:
selecting an adaptive text input mode for the text record based on location information; and
generating a plurality of characters of the text record in conformance with the adaptive text input mode in response to a respective plurality of inputs on the keypad.

2. The method of claim 1 wherein the adaptive text input mode comprises a numeric text input mode and a multi-tap text input mode.

3. The method of claim 1 wherein the plurality of inputs comprises one or more single tap inputs and one or more multi-tap inputs.

4. The method of claim 1 wherein the adaptive text input mode specifies a first text input mode, a second text input mode and a mode delimiter for the text record.

5. The method of claim 1 wherein the location information is acquired by the mobile electronic device from one of a network node and a global positioning system (GPS) satellite.

6. The method of claim 1 wherein the location information is acquired by the mobile electronic device from a user of the mobile electronic device.

7. The method of claim 1 wherein the location information comprises country information.

8. The method of claim 1 wherein the text record comprises street address information.

9. The method of claim 1, wherein the text record comprises calendar date information.

10. A method for generating a hybrid alpha-numeric text record on a mobile electronic device using a keypad, comprising:
selecting an adaptive text input mode specifying a first text input mode, a second text input mode and a mode delimiter applicable to the text record;
in response to one or more first inputs on the keypad, generating one or more first characters of the text record in conformance with the first text input mode;
in response to one or more second inputs on the keypad including the mode delimiter, switching between the first text input mode and the second text input mode; and
in response to one or more third inputs on the keypad, generating one or more second characters of the text record in conformance with the second text input mode.

11. The method of claim 10, wherein the adaptive text input mode is selected based on location information.

12. The method of claim 11 wherein the location information is acquired by the mobile electronic device from one of a network node and a GPS satellite.

13. The method of claim 11 wherein the location information is acquired by the mobile electronic device from a user of the mobile electronic device.

14. The method of claim 11 wherein the location information comprises country information.

15. The method of claim 10 wherein the text record comprises at least one of street address information and calendar date information.

16. A mobile electronic device, comprising:
a memory adapted to store an adaptive text input mode;
a keypad adapted to receive a plurality of inputs; and
a processor communicatively coupled with the memory and the keypad and adapted to select the adaptive text input mode and generate a respective plurality of characters of a text record in conformance with the adaptive text input mode in response to the plurality of inputs.

17. The method of claim 16 wherein the adaptive text input mode comprises a numeric text input mode and a multi-tap text input mode.

18. The method of claim 16 wherein the plurality of inputs comprises one or more single tap inputs and one or more multi-tap inputs.

19. The method of claim 16 wherein the adaptive text input mode specifies a first text input mode, a second text input mode and a mode delimiter for the text record.

20. The method of claim 16 wherein the adaptive text input mode is selected based on location information.
